(19) United States
(12) Patent Application Publication
(10) Pub. No.: US 2007/0144574 A1
(43) Pub. Date: Jun. 28, 2007

(54) Solar battery system and thermoelectric hybrid solar battery system

(75) Inventor: Naoyuki Yada, Tokyo (JP)

Correspondence Address: ARENT FOX PLLC, 1050 CONNECTICUT AVENUE, N.W., SUITE 400, WASHINGTON, DC, 20036, US

(73) Assignee: TAMA-TLO, LTD., HACHIOJI-SHI, TOKYO (JP)

(21) Appl. No.: 10/582,800

(22) PCT Filed: Sep. 28, 2005
(86) PCT No.: PCT/JP05/17854

§ 371 Date: Jun. 14, 2006

(30) Foreign Application Priority Data
Oct. 6, 2004 (JP) 2004-294149
Jan. 25, 2005 (JP) 2005-016755

(51) Int. Cl. H02N 6/00

(52) U.S. Cl. 136/246; 136/251

(57) ABSTRACT

A solar battery system with an improved effect of utilizing solar energy and a thermoelectric hybrid type solar battery system for furthermore recovering heat energy are provided. It is configured to include a solar battery panel 1 receiving sunlight at a light receiving surface 1a and supplying electricity generated by photoelectric conversion to the outside; a heat pipe 2 configured to have a serpentine thin hole provided therein with a sealed refrigerant fluid or configured to have a plate-shaped structure, for example, in a flat shape, a thin shape, furthermore, a thin film shape, wherein a surface of said plate-shaped structure on one end portion side is affixed to a back surface of said light receiving surface of said solar battery panel, and receiving heat H generated at said solar battery panel 1 from said one end portion 2a and conducting to the other end portion 2b; and a heat release part 3, such as a hot water generation part, receiving the heat from the other end portion 2b which is conducted in the heat pipe 2.

### TECHNICAL FIELD

The present invention relates to a solar battery system and a thermoelectric solar battery system, and particularly relates to a solar battery system with improved electric conversion efficiency and a thermoelectric hybrid solar battery system for recovering heat energy in addition to electric energy.

### BACKGROUND ART

Environmental destruction has been proceeding on a global basis and utilization of natural energy has become increasingly necessary for environmental conservation. Most of current consumer use energy is electricity. Supply sources of the electric energy are generated by thermal power and nuclear power, which directly and indirectly give considerable adverse effects on the global environment.

Among a variety of power generation systems using natural energy, a solar battery is the most pervasive power generation system.

As advantages of solar batteries, inexhaustible solar energy, excellent maintainability only requiring the initial investment, and the long power generation lifetime, etc. may be mentioned. However, even though the solar energy is free and inexhaustible, much energy is necessary for producing solar batteries themselves. Accordingly, to convert solar energy to electricity or other useful energy as efficient as possible is considered to be significant in terms of solving energy issues and conserving the environment.

It is known that a generating capacity declines as the surface temperature rises in solar batteries. A limit of a generating effect of a solar battery itself is 15% or so even when cooling the solar battery to attain a higher generating effect. Namely, 85% of solar energy cannot be used as usable energy in solar batteries.

Moreover, the unused 85% of solar energy as heat warms the solar battery panel. In a current solar battery, wherein a temperature rise of the panel deteriorates the generating effect, the unused energy helps deterioration of the generating effect.

Therefore, cooling of a temperature of a solar battery has been studied on an object of improving the generating effect.

On the other hand, a solar water heater, which has been used in many households for long, is capable of providing hot water for bathing from solar energy with a relatively simple facility. In a solar water heater, about 40% of solar energy supplied from sun can be recovered as hot water.

### DISCLOSURE OF THE INVENTION

An object of the present invention is to provide a solar battery system capable of improving an efficiency of using solar energy comparing with that of conventional solar batteries by providing a cooling mechanism, and a thermoelectric hybrid solar battery system also capable of recovering heat energy from the cooling mechanism in addition to improving an efficiency of using as electric energy by the solar battery.

A solar battery system of the present invention comprises a solar battery panel receiving sunlight on a light receiving surface thereof and supplying electricity generated by photoelectric conversion to the outside; a heat pipe having a plate-shaped structure, wherein a surface of the plate-shaped structure on one end portion side is affixed to a back surface of the light receiving surface of the solar battery panel, and receiving heat generated at the solar battery panel from the one end portion and conducting to the other end portion; and a heat release part receiving the heat from the other end portion which is conducted in the heat pipe.

The solar battery system of the present invention includes a solar battery panel, a heat pipe and a heat release part.

The solar battery panel receives sunlight on its light receiving surface and supplies electricity generated by photoelectric conversion to the outside.

The heat pipe is different from a conventional heat pipe having a pipe-shaped structure that a condensed liquid runs through an outer circumferential part of the center portion, wherein a vapor flow of a heat medium runs, and has a plate-shaped structure, wherein a surface of the plate-shaped structure on one end portion side is affixed to a back surface of the light receiving surface of the solar battery panel, and heat generated at the solar battery panel is received from one end portion and conducted to the other end portion.

Here, “plate-shaped” indicates a flat shape, thin shape and, furthermore, a thin film shape, etc. Also, “affixing” means sticking together directly or indirectly, indicating mechanical close contact simply by pressure, welding or adhesion by an adhesive, etc.

The heat release part receives heat conducted through the heat pipe from other end portion side.

Preferably, in the solar battery system of the present invention, a serpentine thin hole running some lengths between the one end portion and the other end portion of the plate-shaped structure is provided inside the plate-shaped structure of the heat pipe, and a refrigerant fluid is sealed in the serpentine thin hole; and more preferably, the refrigerant fluid is sealed, so that liquid phase parts and gas phase parts thereof exist alternately in the serpentine thin hole.

Alternately, preferably, a wick, a pressure-proof structure and an operating fluid are sealed in a movable state inside the plate-shaped structure in the heat pipe.

Also, preferably, the back surface of the solar battery panel and the heat pipe are put together by a heat conductive adhesive.

Preferably, in the solar battery system of the present invention, a surface of the plate-shaped structure on the one end portion side is affixed to a back surface of the light receiving surface of the solar battery panel via a copper plate.

More preferably, the back surface of the solar battery panel is divided to a plurality of fields, a plurality of the heat pipes are affixed to each of the fields via the copper plate, and a fixed area of the heat pipes and the copper plate is smaller than an area of the fields.

Also, furthermore preferably, the back surface of the solar battery panel and the copper plate and/or the copper plate and the heat pipes are put together by a heat conductive adhesive.

Also, a thermoelectric hybrid solar battery system of the present invention comprises a solar battery panel receiving sunlight on a light receiving surface thereof and supplying electricity generated by photoelectric conversion to the outside; a heat pipe having a plate-shaped structure, wherein a surface of the plate-shaped structure on one end portion side is affixed to a back surface of the light receiving surface of the solar battery panel, and receiving heat generated at the solar battery panel from the one end portion and conducting to the other end portion; and a hot water generation part for obtaining hot water by storing water inside, immersing the end portion of the other side of the heat pipe in the water, and transferring the heat conducted in the heat pipe from the other end portion side to the water to heat the water.

Since the hot water generation part and the solar battery panel are separated completely, it is secure from water leakage, furthermore, other fluids than water may be used as the heat medium.

The thermoelectric hybrid solar battery system of the present invention comprises a solar battery panel, heat pipe and a hot water generation part.

The solar battery panel receives sunlight on its light receiving surface and supplies electricity generated by photoelectric conversion to the outside.

The heat pipe is different from a conventional heat pipe having a double structure that a condensed liquid runs through an outer circumferential part of the center portion, wherein a vapor flow of a heat medium runs, and has a plate-shaped structure, wherein a surface of the plate-shaped structure on one end portion side is affixed to a back surface of the light receiving surface of the solar battery panel, and heat generated at the solar battery panel is received from one end portion and conducted to the other end portion.

The hot water generation part has a configuration that water as a heat medium is stored inside, and the end portion of the other side of the heat pipe is immersed in the water; and heat conducted in the heat pipe is conducted from the other end portion side to the water to heat the water, so that hot water is obtained.

In the thermoelectric hybrid solar battery system of the present invention, preferably, a serpentine thin hole running some lengths between the one end portion and the other end portion of the plate-shaped structure is provided inside the plate-shaped structure of the heat pipe, and a refrigerant fluid is sealed in the serpentine thin hole; and more preferably, the refrigerant fluid is sealed, so that liquid phase parts and gas phase parts thereof exist alternately in the serpentine thin hole.

Alternately, preferably, a wick, a pressure-proof structure and an operating fluid are sealed in a movable state inside the plate-shaped structure in the heat pipe.

Also, preferably, the back surface of the solar battery panel and the heat pipe are put together by a heat conductive adhesive.

In the thermoelectric hybrid solar battery system of the present invention, preferably, a surface of the plate-shaped structure on the one end portion side is affixed to a back surface of the light receiving surface of the solar battery panel via a copper plate.

More preferably, the back surface of the solar battery panel is divided to a plurality of fields, a plurality of the heat pipes are affixed to each of the fields via the copper plate, and a fixed area of the heat pipes and the copper plate is smaller than an area of the fields.

Furthermore preferably, the back surface of the solar battery panel and the copper plate and/or the copper plate and the heat pipes are put together by a heat conductive adhesive.

In the thermoelectric hybrid solar battery system, preferably, a heat release accelerator for improving an effect of conducting heat to the water is formed at the end portion of the other side of the heat pipe.

Alternately, preferably, a hot water bath to be supplied with hot water from the hot water generation part is provided.

Also, preferably, the hot water generation part has a tank shape.

Alternately, preferably, the hot water generation part has a pipe shape; and more preferably, the solar battery panel is installed along a slope at an angle with a horizontal plane, and the hot water generation part is provided to be connected to the solar battery panel via the heat pipe at sides arranged to be inclined along the slope of the solar battery panel.

In the solar battery system of the present invention, a heat pipe having excellent heat transferability is arranged on a back surface of the solar battery panel and, by improving the electric conversion efficiency by lowering a temperature of the solar battery panel, the effect of utilizing solar energy is improved comparing with that in conventional solar batteries.

In the thermoelectric hybrid solar battery system of the present invention, a heat pipe having excellent heat transferability is arranged on a back surface of the solar battery panel and, in addition to improving the electric conversion efficiency by lowering the temperature of the solar battery panel, heat energy from the solar battery panel can be recovered, so that the effect of utilizing solar energy is improved comparing with that in conventional solar batteries.

### BRIEF DESCRIPTION OF DRAWINGS

FIG. 1 is a schematic configuration view of a solar battery system according to a first embodiment of the present invention.

FIG. 2A is a schematic perspective view of an example of a heat pipe composing a solar battery system of the first and second embodiments of the present invention, and FIG. 2B is a schematic view showing the configuration in a disassembled state.

FIG. 3 is a schematic view showing an operation principle of a heat transfer of a self-exciting mode oscillating-flow type heat pipe used in the embodiments of the present invention.

FIG. 4A is a plan view of an example of a back surface side of a light receiving surface of a solar battery panel composing the solar battery system of the first and second embodiments of the present invention, and FIG. 4B is a sectional view along a line A-A′ in FIG. 4A.

FIG. 5 is a schematic configuration view of a thermoelectric hybrid solar battery system according to the second embodiment of the present invention.

FIG. 6 is a graph showing experiment results of an example 2.

FIG. 7 is a graph showing experiment results of an example 3.

FIG. 8 is a graph showing experiment results of an example 4.

FIG. 9A is a schematic view showing the configuration of a heat pipe used in the solar battery system according to a third embodiment of the present invention in a disassembled state, and FIG. 9B is a schematic view showing the configuration of the heat pipe and an operation of heat transfer.

FIG. 10 is a schematic configuration view of a thermoelectric hybrid solar battery system according to a fourth embodiment of the present invention.

FIG. 11 is a schematic sectional view of a key part of the thermoelectric hybrid solar battery system according to a fourth embodiment of the present invention.

### EXPLANATION OF REFERENCES

1 solar battery panel
1a light receiving surface
2 heat pipe
2a, 2b end portion of heat pipe
3 heat release part
4 external terminal
5 copper plate
20 middle plate
20a through hole
21, 22 outer plate
23 serpentine thin hole
24 refrigerant fluid
24L liquid phase part
24G gas phase part
25 heat receiving part
26 heat release part
30 hot water generation part
31 water
32 heat insulating material
33 heat release accelerator
34a hot water supply tube
34b return tube
35 hot water bath
36 circulation pump
37a flow amount adjustment cock
37b drain cock
38 agent adding part
40 container
41 wick
42 pressure-proof structure
43 heat receiving part
44 vapor
45 condensing part
46 operation liquid
50 roof
H heat
HS heat source

### BEST MODE FOR CARRYING OUT THE INVENTION

Below, a solar battery system and a thermoelectric hybrid solar battery system according to embodiments of the present invention will be explained with reference to the drawings.

### First Embodiment

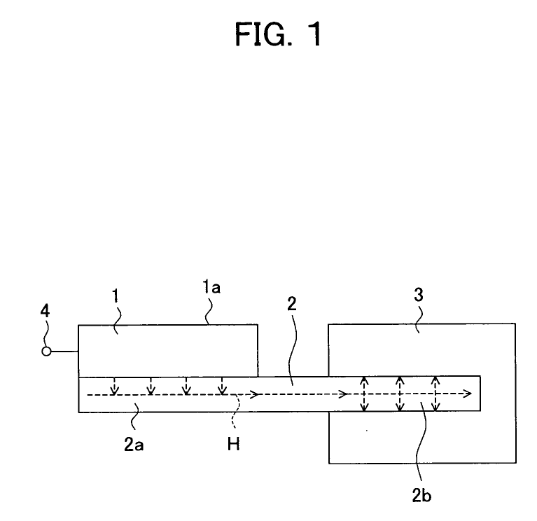

FIG. 1 is a schematic configuration view of a solar battery system according to the present embodiment.

The solar battery system of the present embodiment includes a solar battery panel 1, a heat pipe 2 and a heat release part 3.

The solar battery panel 1 receives sunlight on a light receiving surface la thereof and supplies power generated by photoelectric conversion to the outside from an external terminal 4, etc.

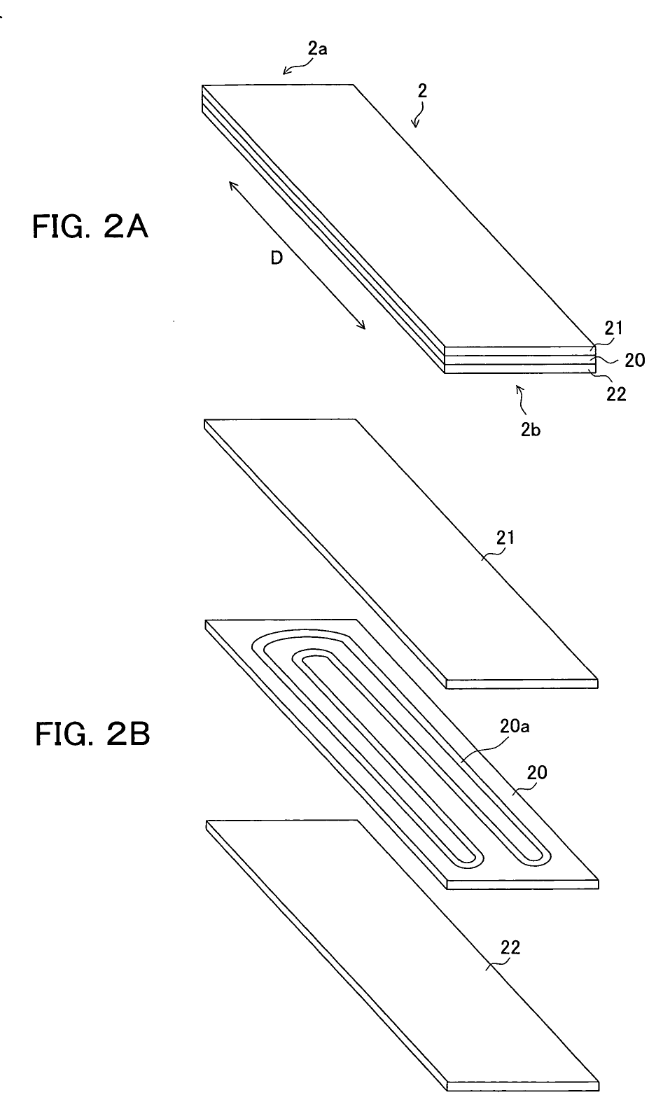

As shown in the schematic perspective view of FIG. 2A, the heat pipe 2 is configured to have a serpentine thin hole running some lengths between one end portion 2a and the other end portion 2b of a plate-shaped structure along the heat transfer direction D inside of the plate-shaped structure, and a refrigerant fluid is sealed in the serpentine thin hole. The serpentine thin hole is one loop-shaped thin hole arranged to be a serpentine shape.

For example, as shown in the schematic perspective view in FIG. 2A and the schematic view in FIG. 2B showing the same disassembled, three plates (20, 21 and 22) made by a heat conductive material, such as a metal, are stacked to compose the plate-shaped structure. In the plate-shaped structure, the middle plate 20 has a through hole 20a, two outer plates (21 and 22) are affixed to both surfaces of the middle plates 20 and, from an inner wall surface of the through hole portion 20a of the middle plate 20 and from a surface of the outer plates (21 and 22) inside of such a plate-shaped structure, the serpentine thin hole is formed to be arranged to run some lengths (two lengths in the figure) between the one end portion 2a and the other end portion 2b of the plate-shaped structure. A size (diameter or one side) of the serpentine thin hole is, for example, 1 mm or so.

Also, inside the serpentine thin hole, a refrigerant fluid, for example, made by CFC's substitute, such as R134a, alcohol or other volatile fluid is sealed in a state where liquid phase parts and gas phase parts of the refrigerant fluid exist alternately.

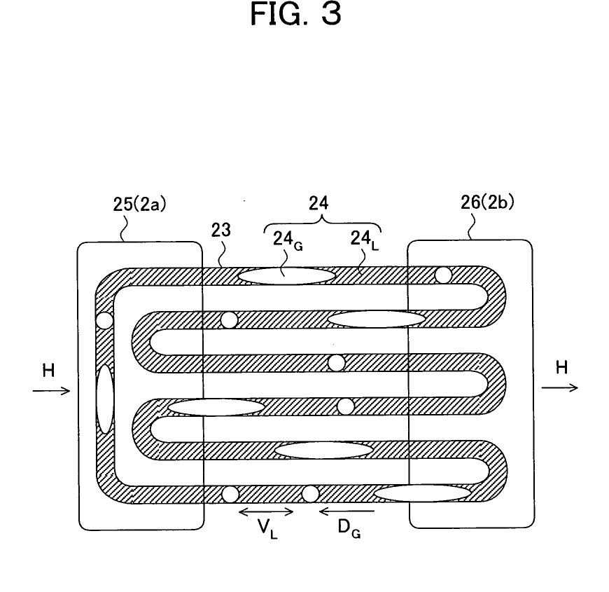

FIG. 3 is a schematic view showing an operation principle of heat transfer of the heat pipe explained above.

The plate-shaped heat pipe 2 configured as above is a so-called a self-exciting mode oscillating-flow type heat pipe and is different from a heat pipe of a type having a configuration that a condensed liquid runs through an outer circumferential part of the center portion, wherein a vapor flow of a heat medium runs.

Inside the serpentine thin hole 23 of the heat pipe, liquid phase parts 24_{L} and gas phase parts 24_{G} of the refrigerant fluid 24 in an alternating state are sealed. When heat H is absorbed at a heat receiving part 25 as one end portion 2a of the plate-shaped structure, vapor bubbles of the refrigerant fluid are generated intermittently inside the serpentine thin hole 23 due to the heat quantity, which leads to rise of the temperature and vapor pressure.

On the other hand, at the heat release part 26 at the other end portion 2b, heat H is released, so that temperature and pressure of the vapor bubbles decline due to the cooling action. As a result of a pressure difference between the heat receiving portion 25 and the heat releasing portion 26, a gas phase and liquid phase sealed alternately in the serpentine thin hole move to the heat release part side at a time.

At this time, the movement D_{G} of the gas phase causes transfer of latent heat, self-exciting mode oscillating-flow V_{L} arises in the liquid phase to transfer sensible heat and, as a result that the gas phase part and liquid phase part move at a time, both of the latent heat and sensible heat transfer, so that heat transfer is performed rapidly and efficiently.

To realize an optimal heat pipe for the solar battery system of the present embodiment, it is significant to select an optimal kind and fill ration (filling pressure) for the refrigerant fluid above and, furthermore, to layout an optimal serpentine pattern of the serpentine thin hole.

A surface of the plate-shaped structure on one end part 2a side of the heat pipe 2 configured as above is affixed to the back surface of the light receiving surface 1a of the solar battery panel 1 by a heat conductive adhesive, such as a thermal compound (adhesive containing metal powder), and receives heat generated by the solar battery panel 1 from one end portion 2a and conducts to the other end portion 2b.

The heat release part 3 receives heat carried through the heat pipe 2 from the other end portion side. It is sufficient if it is configured to release heat H conducted through the heat pipe 2 and, for example, a water-cooling apparatus and an air-cooling apparatus, etc. may be used.

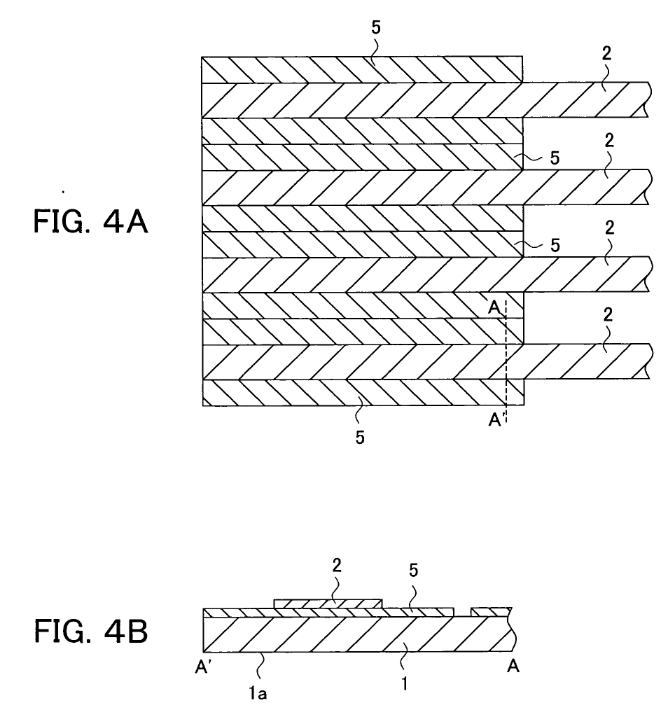

As shown in a plan view on the back surface side of the light receiving surface of the solar battery panel in FIG. 4A and in FIG. 4B as a sectional view along a line A-A′ in FIG. 4A, the surface of the plate-shaped structure on one end portion 2a side of the heat pipe 2 and the back surface of the light receiving surface 1a of the solar battery panel 1 may be put together via a copper plate 5.

In that case, it is preferable to be configured that the back surface of the solar battery panel 1 is divided to a plurality of fields, a plurality of heat pipes 2 are affixed to each of the fields via a copper plate, and a fixed area of the heat pipe 2 and the copper plate 5 is smaller than that of each field divided on the back surface of the solar battery panel 1. Since the copper plate has a high heat recovery effect, heat release of the solar battery panel can be sufficiently effectively performed without affixing the heat pipe to the whole surface of the back surface of the solar battery panel when the copper plate is provided.

Also, to improve the heat release efficiency, the back surface of the solar battery panel 1 and the copper plate 5 and/or the copper plate 5 and the heat pipe 2 are preferably put together with a heat conductive adhesive, such as thermal compound (adhesive containing metal powder), in the above configuration.

Also, the copper plate and the heat pipe may be formed to be one body, that is, it may be configured to form the serpentine thin hole inside of the copper plate and sealing a refrigerant fluid therein. As a result, a reduction of weight of the apparatus can be realized.

In the solar battery system of the present embodiment explained above, a self-exciting mode oscillating-flow type heat pipe having excellent heat transferability is provided on the back surface of the solar battery panel, consequently, a temperature of the solar battery panel can be lowered, the electric conversion efficiency can be improved, for example, by 40%, and an efficiency of utilizing solar energy can be improved comparing with that of conventional solar batteries. Accordingly, effective use of energy resources can be attained and it is possible to contribute to conservation of the global environment.

In that case, by using a plate-shaped heat pipe, the heat pipe can be provided by being closely affixed to the solar battery panel and buried in a flame for supporting the solar battery, so that the self-exciting mode oscillating-flow type heat pipe having the plate structure is advantageous both in terms of heat transferability and a structural aspect.

### Second Embodiment

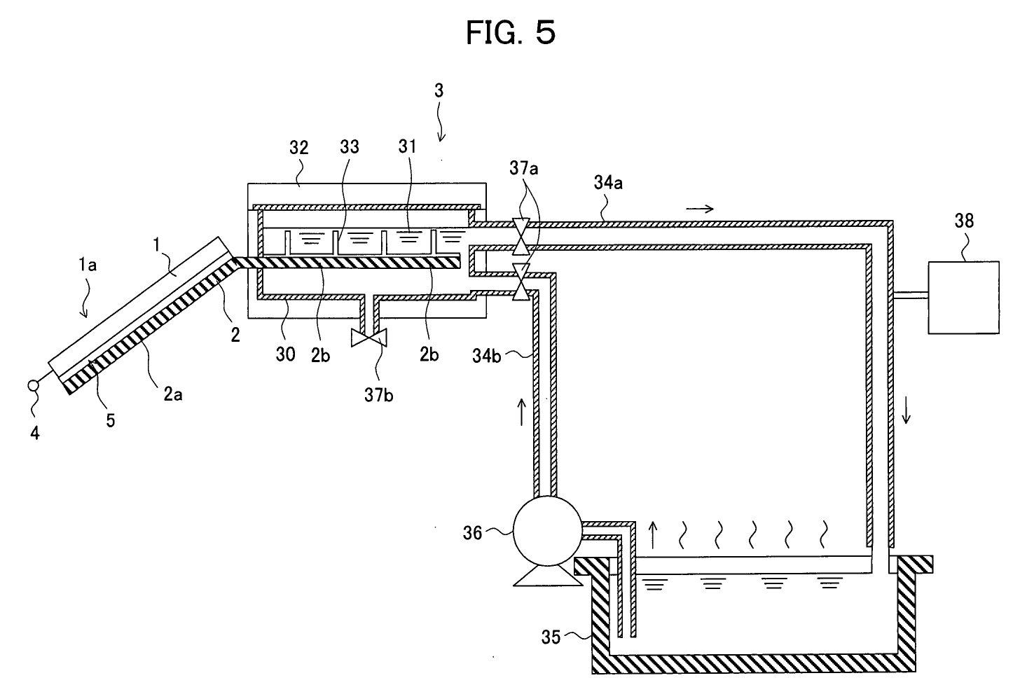

FIG. 5 is a schematic configuration view of a thermoelectric hybrid solar battery system according to the present embodiment.

The solar battery system of the present embodiment includes a solar battery panel 1, a heat pipe 2 and a tank-shaped hot water generation part 30 as a heat release part 3.

The solar battery panel 1 and the heat pipe 2 have the same configurations as those in the first embodiment.

The solar battery panel 1 receives sunlight on its light receiving surface 1a and supplies power generated by photoelectric conversion to the outside from the external terminal 4, etc.

The heat pipe 2 is configured to have a serpentine thin hole running some lengths between one end portion 2a and the other end portion 2b of a plate-shaped structure inside of the plate-shaped structure, and a refrigerant fluid is sealed in the serpentine thin hole. It is a so-called self-exciting mode oscillating-flow type heat pipe.

A surface of the plate-shaped structure on the one end portion side of the heat pipe 2 above is affixed to a back surface of the light receiving surface 1a of the solar battery panel 1 with a heat conductive adhesive, such as a thermal compound (adhesive containing metal powder), receives from one end portion 2a heat generated by the solar battery panel 1 and conducts to the other end portion 2b.

In the same way as in the first embodiment, as shown in FIG. 5, the surface of the plate-shaped structure on the one end portion 2a side may be affixed to the back surface of the light receiving surface 1a of the solar battery panel 1 via a copper plate 5.

The hot water generation part 30 is configured to store inside thereof, for example, water 31 as a heat medium and an end portion of the other side of the heat pipe 2 is immersed in the water 31 inside.

Heat H carried through the heat pipe 2 is conducted from the other end portion side of the heat pipe 2 to the water 31 to heat the water 31, so that hot water is obtained.

The solar battery panel 1 has to be installed to have a predetermined slope according to a roof slope, etc. to receive sunlight effectively. While, the tank-shaped hot water generation part 30 is to be installed, so that, for example, an upper surface of an approximate rectangular parallelepiped shape becomes horizontal, though it depends on a shape of the tank. In that case, the heat pipe 2 for transfer heat between the solar battery panel 1 and the hot water generation part 30 has a bent part. The plate-shaped self-exciting mode oscillating-flow type heat pipe used in the present embodiment can be bent to a certain degree of angle at any part due to the configuration, and heat transfer between the solar battery panel 1 and the hot water generation part 30 can be performed efficiently.

To improve the effect of heating water, an outer circumferential part of the hot water generation part 30 is preferably covered with a heat insulating material 32.

Also, it is preferable that a heat release accelerator 33, such as a heat release fin, for improving the effect of conducting heat to the water 31 is formed at the other end portion of the heat pipe 2.

Hot water obtained by being heated in the hot water generation part 30 can be used for various use objects.

For example, hot water may be supplied to a bath 35 through a hot water supply tube 34a connected to the hot water generation part 30 and used for footbath or fullbody bath. A return tube 34b for feeding back hot water from the bath 35 to the hot water generation part 30 in accordance with need may be provided, and the hot water may be circulated by a circulation pump 36. In that case, a purification filter or a disinfection apparatus is preferably provided to inside of the circulation pump 36 or to the return tube 34b so as to maintain the hot water clean. A supply amount of the hot water may be adjusted by a flow amount adjusting cock 37a provided, for example, to the hot water supply tube 34a and the return tube 34b.

Also, an agent adding part 38 for a bath agent, etc. may be provided at the middle of the hot water supply tube 34a in accordance with need.

Furthermore, a drain cock 37b may be provided directly to the hot water generation part 30 to discharge water inside.

Also, use of the hot water is not limited to bathing, such as footbath, and may be used for hot water supply to a kitchen, etc.

Furthermore, when a temperature of the hot water is lower than desired, electricity obtained by the solar battery panel may be used to heat to a desired temperature.

The solar battery system of the present embodiment explained above is a thermoelectric hybrid solar battery system, by which electricity can be obtained by generating it by the solar battery panel and, furthermore, heat generated at the solar battery panel can be conducted to the hot water generation part to obtain hot water for use.

A self-exciting mode oscillating-flow type heat pipe having excellent heat transferability is provided to the back surface of the solar battery panel, thus, temperature of the solar battery panel can be lowered to improve the electric conversion efficiency to, for example, 40%. Therefore, the use efficiency of solar energy can be improved comparing with that in the conventional solar batteries.

Furthermore, heat generated at the solar battery panel can be effectively recovered to obtain hot water for supply, so that energy resources, such as fossil fuels, conventionally used for obtaining hot water can be saved.

As a result, saving and effective utilization of energy resources can be attained and it is possible to contribute to conservation of the global environment.

In that case, by using a plate-shaped heat pipe, the heat pipe may be provided by being closely affixed to the solar battery panel and buried in a flame for supporting the solar battery, so that the self-exciting mode oscillating-flow type heat pipe having the plate structure is advantageous both in terms of heat transferability and a structural aspect.

Also, for an already installed solar battery system, by simple engineering work of attaching a self-exciting mode oscillating-flow type heat pipe to the back surface of the solar battery panel, the electricity conversion efficiency can be improved by 50% or so. It is possible to improve an old solar battery system exhibiting a low electric conversion efficiency to give almost the same electricity generating performance as that of the latest model solar battery.

Furthermore, by using a hot water supply system together, an energy independent house can be attained by building a thermoelectric hybrid solar battery system as explained above.

### EXAMPLE 1

Based on the second embodiment explained as above, a thermoelectric hybrid solar battery system was produced.

Namely, to the back surface of the light receiving surface of a commercially available solar battery panel, one end portion of a Heatlane plate (made by TS Heatronics Co. Ltd.) was affixed as a plate-shaped self-exciting mode oscillating-flow type heat pipe via a copper plate having a thickness of 1.5 mm. At this time, the back surface of the solar battery panel was divided to fields, each having a width of two times a width of an area for affixing the solar battery panel to the heat pipe, that is, divided for every two times an area of the affixing surface, and the heat pipe was affixed to the center part of each field.

Also, at the other end portion of the heat pipe, a tank-shaped hot water generation part configured as shown in FIG. 5 was provided. A heat release fin was provided as a heat release accelerator on the surface of a part of the heat pipe to be immersed in water in the tank.

### EXAMPLE 2

A temperature of the back surface of the light receiving surface of the solar battery panel of the thermoelectric hybrid solar battery system of the example 1 as explained above was measured. Also, a temperature of the back surface of a solar battery panel, to which the heat pipe is not affixed, was measured as a comparative example.

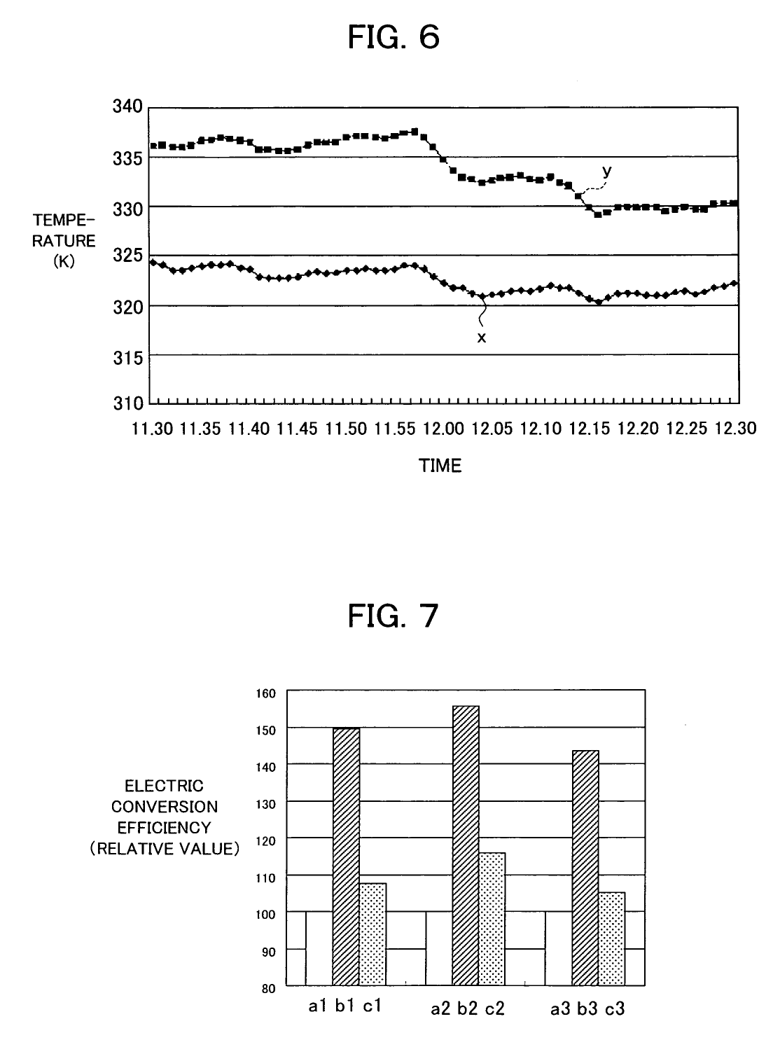

FIG. 6 is a graph showing the experiment results. In the figure, “x” indicates a measurement result of the example and “y” indicates a measurement result of the comparative example. The axis of abscissa is time, and the axis of ordinate is temperature (K).

In the comparative example (y), the temperature was around 335 K (about 62° C.) until 12 o'clock and became 330 K (about 57° C.) after that. On the other hand, in the example (x), the temperature was around 324 K (about 51° C.) until 12 o'clock and became 322 K (about 49° C.) after that. As above, a temperature of the back surface of the solar battery panel of the example was lower at any time.

As explained above, as a result that the self-exciting mode oscillating-flow type heat pipe is affixed to the back surface of the solar battery panel, it was possible to lower the temperature of the back surface of the solar battery panel by 11° C. or so until 12 o'clock with strong sunlight and by 8° C. or so after that with weaker sunlight.

The data is experiment results in a winter season with a relatively smaller sunlight amount, however, in a summer season when a temperature of the solar battery panel becomes higher, a better cooling effect than that shown in the figure is expected.

### EXAMPLE 3

An electric conversion efficiency of the solar battery panel of the thermoelectric hybrid solar battery system of the example 1 explained above was measured. Also, the electric conversion efficiency was measured in the case of a solar battery panel, to which the heat pipe is not affixed, as a comparative example and the case where a conventional general heat pipe not having a plate structure is affixed to the back surface of the solar battery panel.

FIG. 7 is a graph showing the experiment results. In the figure, reference numbers a1 to a3 indicate results of a comparative example with no heat pipes, b1 to b3 indicate results of the example, and c1 to c3 indicate results of the comparative example with a conventional heat pipe. Results of conducting simultaneous experiments for three times are shown, respectively. The axis of abscissa indicates an electric conversion efficiency (relative value) by assuming that results of a1 to a3 are 100.

The three-time experiments are conducted on different day and time under different condition, so that the data values vary, however, in any of the three-time experiments, results (b1 to b3) of the example using the self-exciting mode oscillating-flow type heat pipe attain higher electric conversion efficiencies than those in the results (c1 to c3) of the comparative example using the conventional heat pipe, exhibit relatively improved effects by about 40% comparing with the results (c1 to c3) of the comparative example using the conventional general heat pipe and exhibit relatively improved effects by about 50% comparing with the results (a1 to a3) of the comparative example not using any heat pipes.

### EXAMPLE 4

An energy recovery efficiency of a total of electric energy and heat energy of the thermoelectric hybrid solar battery system of the example 1 as explained above with respect to energy of the entire sunlight was measured. Also, as a comparative example, an energy recovery efficiency was measured on the solar battery system, to which a heat pipe is not affixed. In the comparative example, since a heat recovery system is not provided, the electric conversion efficiency itself is the recovery efficiency of energy. An improved amount of the energy recovery efficiency of the example is a sum of an improved amount of an electric conversion efficiency by cooling of the solar battery panel and an improved amount of efficiency by recovering heat energy.

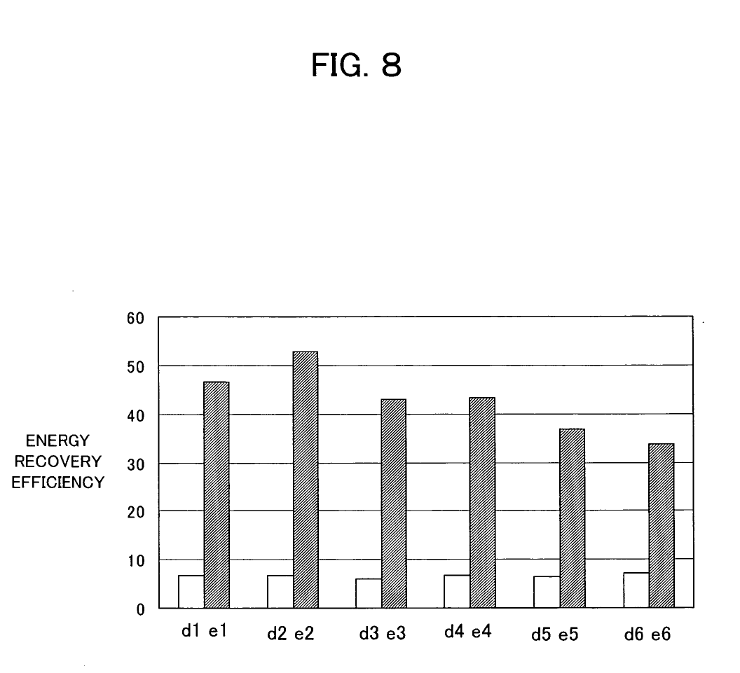

FIG. 8 is a graph showing the experiment results. In the figure, reference numbers d1 to d6 indicate results of the example, and e1 to e6 indicate results of comparative example, to which a heat pipe is not affixed. Results of conducting simultaneous experiments for six times on different days are shown, respectively. The axis of abscissa indicates an energy recovery effect (%) to energy of entire sunlight.

From FIG. 8, in the solar battery with no heat pipe, the energy recovery efficiency was less than 10%, while in the example, about 40 to 50% of energy recovery efficiency was realized.

### Third Embodiment

In the present embodiment, a heat pipe to be used in the solar battery systems in the first and second embodiments explained above are modified as below.

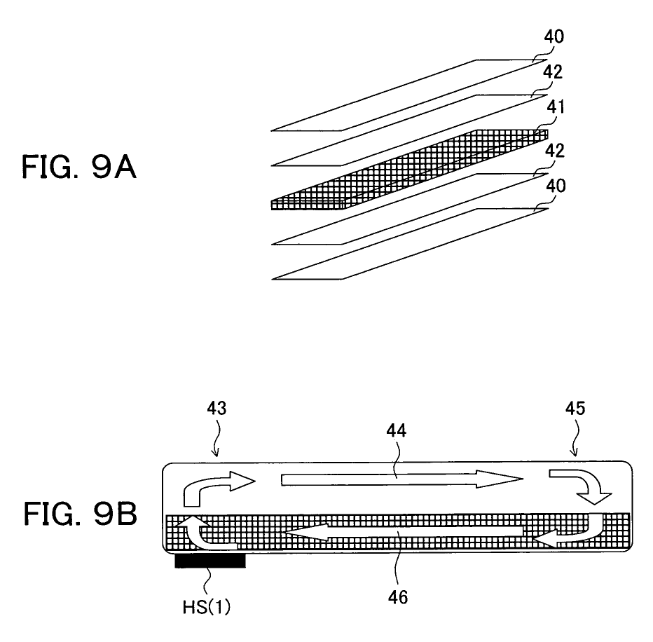

FIG. 9A is a schematic view showing the configuration of a heat pipe used in the solar battery system according to the present embodiment in a disassembled state, and FIG. 9B is a schematic view showing the configuration of the heat pipe and an operation of heat transfer.

The heat pipe used in the present embodiment is formed by sealing therein a wick 41 for generating capillary force, a pressure-proof structure 42 and a small amount of operating fluid (liquid having a high latent heat, such as water and alcohol) in a movable state inside a container as a plate-shaped structure formed by a thin metal foil, and closely sealing by discharging all air.

The heat receiving part 43 of the heat pipe configured as above contacts a hear source HS as the solar battery panel 1, wherein the saturated vapor pressure of the operation liquid becomes high when heat is received and evaporated, and the heat is absorbed as vapor latent heat of the liquid.

Vapor 44 of the operation liquid is dispersed in every corner in a space formed in the wick and condensed at a condensing part 45 having a relatively low temperature.

The condensed operation liquid 46 is absorbed by the wick and flows back to the heat receiving part due to the gravity and a capillary force.

Due to the circulation of the operation liquid using phase changes as explained above, heat transfer becomes possible between those having an extremely small temperature difference. Also, by changing the operation liquid to be sealed in the heat pipe, it is possible to deal with a variety of temperature conditions and heat transfer conditions.

In the heat pipe used in the present embodiment, the wick and the pressure-proof structure are movable inside, so that distortion is absorbed when bent, blockage of the space due to buckling is not caused and flexibility is obtained. Therefore, when used in the solar battery system of the present invention, it can be easily affixed to the solar battery panel and easily bent when connecting the solar battery panel and the hot water generation part, etc.

In the solar battery system of the present embodiment, the plate-shaped heat pipe is arranged on the back surface of the solar battery panel, so that a temperature of the solar battery panel is lowered to improve the electric conversion efficiency and an efficiency of utilizing solar energy can be improved comparing with that in a conventional solar battery. As a result, energy resources can be utilized effectively and it is possible to contribute to conservation of the global environment.

### Fourth Embodiment

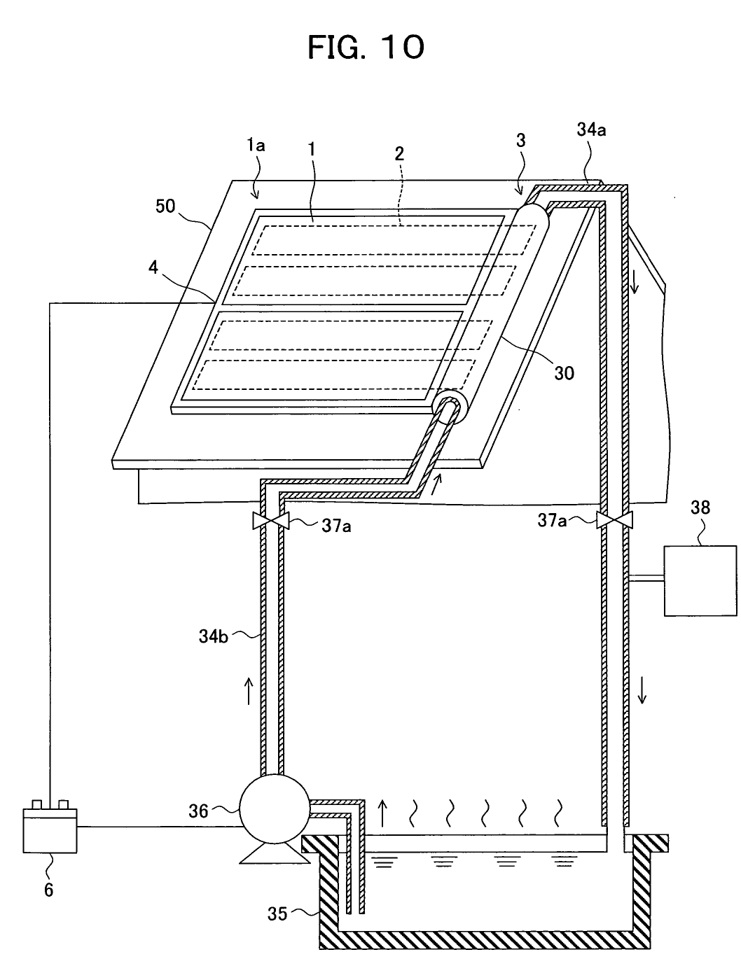

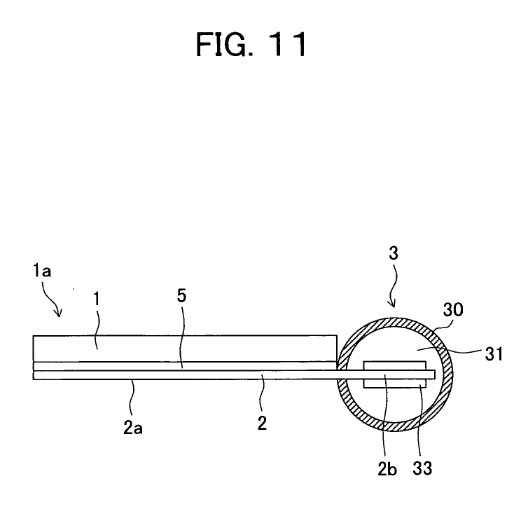

FIG. 10 is a schematic configuration view of a thermoelectric hybrid solar battery system according to the present embodiment and FIG. 11 is a schematic sectional view of the key part.

The solar battery system of the present embodiment includes a solar battery panel 1, a heat pipe 2 and a pipe-shaped hot water generation part 30 as a heat release part 3.

Configurations of the solar battery panel 1 and the heat pipe 2 are the same as those in the first embodiment.

The solar battery panel 1 receives sunlight on a light receiving surface 1a thereof and supplies electricity generated by photoelectric conversion from the external terminal 4 to a battery 6 for storing.

The heat pipe 2 is configured to have a serpentine thin hole running some lengths between one end portion 2a and the other end portion 2b of a plate-shaped structure inside of the plate-shaped structure, and a refrigerant fluid is sealed in the serpentine thin hole. It is a so-called self-exciting mode oscillating-flow type heat pipe.

A surface of the plate-shaped structure on the one end portion side of the heat pipe 2 above is affixed to a back surface of the light receiving surface 1a of the solar battery panel 1 by a heat conductive adhesive, such as a thermal compound (adhesive containing metal powder), receives from one end portion 2a heat generated by the solar battery panel 1 and conducts to the other end portion 2b.

In the same way as in the first and second embodiments, as shown in FIG. 11, the surface of the plate-shaped structure on the one end portion 2a side may be affixed to the back surface of the light receiving surface 1a of the solar battery panel 1 via a copper plate 5.

The pipe-shaped hot water generation part 30 is configured to be composed of a resin pipe inside thereof for storing water 31 as a heat medium, a thin long opening is formed to be inserted by the heat pipe 2, and an end portion on the other side of the heat pipe 2 is immersed in the water 31 inside. A space between the opening of the resin pipe and the heat pipe is sealed by a seal material. An area required by the pipe-shaped hot water generation part can be made smaller.

Heat H carried through the heat pipe 2 is conducted from the other end portion side of the heat pipe 2 to the water 31 to heat the water 31, so that hot water is obtained.

The solar battery panel 1 is preferably installed to have a slope of 20° with respect to a horizontal plane so as to receive sunlight effectively.

In the present embodiment, it is installed according to a slope of a roof 50 or to have a predetermined slope by adjusting based on the roof slope. Accordingly, one side of the solar battery panel 1 is arranged on the upper slope, the facing side is arranged on the lower slope, and remaining two sides face to each other and are arranged to have an inclination along with the slope.

Here, in the present embodiment, the hot water generation part 30 is provided to be connected to the solar battery panel via the heat pipe at the sides arranged to have inclination along with the slope.

As explained above, as a result that the area for a pipe-shaped hot water generation part is made smaller, it becomes possible to be arranged to contact the side arranged to have inclination along with the slope of the solar battery panel 1; and as a result that an area for the hot water generation part is made smaller, the present thermoelectric hybrid solar battery system can be downsized, furthermore, even when water leakage from the hot water generation part arises, the adverse effect on the solar battery panel can be suppressed to the minimum.

The heat pipe used in the present embodiment is self-exciting mode oscillating-flow type and capable of transferring heat regardless of relationship of heights of the heat pipe on the heat receiving side and the heat releasing side, however, it is preferably installed, so that the heat release side becomes higher than the heat receiving side with reference to the horizontal plane to transfer heat effectively.

In the present embodiment, the heat pipe is arranged, so that the extending direction is in parallel with sides arranged at the upper sole or lower slope of the solar battery panel 1, that is, approximately horizontally, so that the heights of the heat receiving part and the heat release part are approximately the same. However, when it is arranged, so that the extending direction of the heat pipe crosses at an angle with a side arranged on the upper or lower slope of the solar battery panel 1 to be inclined on the solar battery panel, the heat receiving side can be higher than the heat releasing side.

To improve an effect of heating water, it is preferable that an outer circumferential part of the hot water generation part 30 is covered with a not shown heat insulating material.

Also, it is preferable that a fin or a plate-shaped heat release accelerator 33 for improving the heat conducting efficiency is formed at the other end portion of the heat pipe 2.

Hot water obtained by being heated in the hot water generation part 30 may be used for a variety of use objects, such as footbath, fullbody bath or hot water supply to a kitchen.

A supply amount of the hot water may be adjusted by a flow amount adjusting cock 37a provided, for example, to the hot water supply tube 34a and the return tube 34b. Also, the heat receiving speed for the hot water generation part 30 to receive can be adjusted by the flow amount, so that temperature of the hot water can be adjusted.

For example, the circulation pump 36 can be driven by the battery 6 charged by electricity from the solar battery panel 1.

For example, it is possible to set to drive circulation during day time while charging and stop during night.

Also, an agent adding part 38 for a bath agent, etc. may be provided at the middle of the hot water supply tube 38 in accordance with need.

The heat pipe in the third embodiment can be also used in the present embodiment.

The solar battery system of the present embodiment explained above is a thermoelectric hybrid solar battery system, by which electricity can be obtained by generating it by the solar battery panel and, furthermore, heat generated at the solar battery panel can be conducted to the hot water generation part to obtain hot water for use.

The present invention is not limited to the above explanations.

For example, by storing a larger electricity generating amount than that in the conventional solar battery and charging heat recovered by the self-exciting mode oscillating-flow type heat pipe, it is possible to build a self-sufficient system of electric and heat energy and an independent energy supply system for the case where a lifeline is blocked due to disaster, etc.

Also, the system itself can be build as a compact power generator, so that it can be used as an individual energy supply system.

The heat medium for receiving heat in the heat release part is not limited to water. For example, heat conductive gases, such as the air, carbon dioxide and chlorofluorocarbon, and liquids other than water can be used and, by converting heat from the heat medium to water, etc. again, the heat can be used as hot water.

Other than the above, a variety of modifications may be made within the scope of the present invention.

### INDUSTRIAL APPLICABILITY

The solar battery system of the present invention can be applied to a system for generating electricity by receiving sunlight.

Also, the thermoelectric hybrid solar battery system of the present invention can be applied to a power generating system combining heat and electricity able to be used for bath and other hot water supply facilities by generating electricity by receiving sunlight and, furthermore, generating hot water by recovering heat energy obtained from sunlight.

1: A solar battery system comprising:
a solar battery panel receiving sunlight on a light receiving surface thereof and supplying electricity generated by photoelectric conversion to the outside;
a heat pipe having a plate-shaped structure, wherein a surface of said plate-shaped structure on one end portion side is affixed to a back surface of said light receiving surface of said solar battery panel, and receiving heat generated at said solar battery panel from said one end portion and conducting to the other end portion; and
a heat release part receiving said heat from said other end portion which is conducted through said heat pipe.

2: A solar battery system as set forth in claim 1, wherein a serpentine thin hole running some lengths between said one end portion and said other end portion of said plate-shaped structure is provided inside the plate-shaped structure of said heat pipe, and a refrigerant fluid is sealed in said serpentine thin hole.

3: A solar battery system as set forth in claim 2, wherein said refrigerant fluid is sealed, so that liquid phase parts and gas phase parts thereof exist alternately in said serpentine thin hole.

4: A solar battery system as set forth in claim 1, wherein a wick, a pressure-proof structure and an operating fluid are sealed in a movable state inside the plate-shaped structure in said heat pipe.

5: A solar battery system as set forth in any one of claims 1 to 4, wherein said back surface of said solar battery panel and said heat pipe are put together by a heat conductive adhesive.

6: A solar battery system as set forth in claim 5, wherein a surface of said plate-shaped structure on said one end portion side is affixed to a back surface of said light receiving surface of said solar battery panel via a copper plate.

7: A solar battery system as set forth in claim 6, wherein said back surface of said solar battery panel is divided to a plurality of fields, a plurality of said heat pipes are affixed to each of said fields via said copper plate, and a fixed area of said heat pipes and said copper plate is smaller than an area of said fields.

8: A solar battery system as set forth in claim 7, wherein said back surface of said solar battery panel and said copper plate and/or said copper plate and said heat pipes are put together by a heat conductive adhesive.

9: A thermoelectric hybrid solar battery system, comprising:
a solar battery panel receiving sunlight on a light receiving surface thereof and supplying electricity generated by photoelectric conversion to the outside;
a heat pipe having a plate-shaped structure, wherein a surface of said plate-shaped structure on one end portion side is affixed to a back surface of said light receiving surface of said solar battery panel, and receiving heat generated at said solar battery panel from said one end portion and conducting to the other end portion; and
a hot water generation part for obtaining hot water by storing water inside, immersing the end portion of said other side of said heat pipe in said water, and transferring said heat conducted in said heat pipe from said other end portion side to said water to heat said water.

10: A thermoelectric hybrid solar battery system as set forth in claim 9, wherein a serpentine thin hole running some lengths between said one end portion and said other end portion of said plate-shaped structure is provided inside the plate-shaped structure of said heat pipe, and a refrigerant fluid is sealed in said serpentine thin hole.

11: A thermoelectric hybrid solar battery system as set forth in claim 10, wherein said refrigerant fluid is sealed, so that liquid phase parts and gas phase parts thereof exist alternately in said serpentine thin hole.

12: A solar battery system as set forth in claim 9, wherein a wick, a pressure-proof structure and an operating fluid are sealed inside the plate-shaped structure in said heat pipe.

13: A thermoelectric hybrid solar battery system as set forth in claim 12, wherein said back surface of said solar battery panel and said heat pipe are put together by a heat conductive adhesive.

14: A thermoelectric hybrid solar battery system as set forth in claim 13, wherein a surface of said plate-shaped structure on said one end portion side is affixed to a back surface of said light receiving surface of said solar battery panel via a copper plate.

15: A thermoelectric hybrid solar battery system as set forth in claim 14, wherein said back surface of said solar battery panel is divided to a plurality of fields, a plurality of said heat pipes are affixed to each of said fields via said copper plate, and a fixed area of said heat pipes and said copper plate is smaller than an area of said fields.

16: A thermoelectric hybrid solar battery system as set forth in claim 15, wherein said back surface of said solar battery panel and said copper plate and/or said copper plate and said heat pipes are put together by a heat conductive adhesive.

17: A thermoelectric hybrid solar battery system as set forth in claim 16, wherein a heat release accelerator for improving an effect of conducting heat to said water is formed at the end portion of said other side of said heat pipe.

18: A thermoelectric hybrid solar battery system as set forth in claim 17, comprising a hot water bath to be supplied with hot water from said hot water generation part.

19: A thermoelectric hybrid solar battery system as set forth in claim 18, wherein said hot water generation part has a tank shape.

20: A thermoelectric hybrid solar battery system as set forth in any one of claims 9 to 18, wherein said hot water generation part has a pipe shape.

21: A thermoelectric hybrid solar battery system as set forth in claim 20, wherein:
said solar battery panel is installed along a slope at an angle with a horizontal plane; and
said hot water generation part is provided to be connected to said solar battery panel via said heat pipe at sides arranged to be inclined along said slope of said solar battery panel.
